(19) United States
(12) Patent Application Publication
(10) Pub. No.: US 2015/0180818 A1
(43) Pub. Date: Jun. 25, 2015

(54) Interface for Product Reviews Identified in Online Reviewer Generated Content

(71) Applicant: Google Inc., Mountain View, CA (US)

(72) Inventor: Jack Chen, Princeton, NJ (US)

(21) Appl. No.: 13/906,431

(22) Filed: May 31, 2013

(51) Int. Cl. H04L 12/58

(52) U.S. Cl. CPC H04L 51/32

(57) ABSTRACT

Systems and methods for facilitating the exchange of information relating to product review data expressed by a reviewer with a social media platform or in other platforms are provided. More particularly, a reviewer can optionally surface product review data extracted from reviewer generated content. The product review data can include a sentiment expression about a product or service. The reviewer can optionally make the product review data available to a third party entity that might be interested in the product review data. An interface can be provided between the reviewer and the entity that enables the entity to interact with reviewer. For instance, the entity can offer an incentive to the reviewer for a specified use of the product review data.

### FIELD

The present disclosure relates generally to reviews, and more particularly to a system and method for facilitating the exchange information relating to product reviews identified in social media and other reviewer generated content.

### BACKGROUND

Many online content providers allow users to review products and/or services. These reviews are typically published to assist others in evaluating the products or services and in making purchase decisions. A user researching a product or service will often use Internet search engines to search for reviews and to sift through the myriad of results that are returned by the search engine. Businesses and other entities can desire that reviewers submit favorable reviews about the products and/or services of the business to encourage commercial interaction with the business.

Many people share comments about products and services in their social media platform and other platforms, such as through email, blogs, documents, etc. For instance, users may praise or criticize a product in comments provided to members of their social network. These comments typically can be representative of a reviewer's true sentiment about a product or service. In this connection, social media and other platforms, with user consent, have analyzed social media content to assess information about products or services. In certain cases, comments made by a reviewer in a social media platform may only be shared with members of the reviewer's social media network. These comments may not be available to the general public.

### SUMMARY

Aspects and advantages of the invention will be set forth in part in the following description, or may be obvious from the description, or may be learned through practice of the invention.

One exemplary aspect of the present disclosure is directed to a computer-implemented method of facilitating the exchange of information related to online product reviews. The method includes accessing, with a computing device, reviewer generated content associated with the reviewer. The reviewer generated content includes information about a product or service. The method further includes analyzing, with the computing device, the reviewer generated content to extract product review data. The product review data includes a sentiment expression and an identity of a product or service. The method further includes identifying an entity associated with the product or service identified in the product review data and establishing an interface between the reviewer and the entity. The interface permits the exchange of information between the reviewer and the entity.

Other exemplary aspects of the present disclosure are directed to systems, apparatus, non-transitory computer-readable media, user interfaces and devices for facilitating the exchange of information related to online product reviews.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an overview of an exemplary system according to an exemplary embodiment of the present disclosure;

FIG. 2 depicts a flow diagram of an exemplary method according to an exemplary embodiment of the present disclosure;

FIG. 3 depicts a flow diagram of an exemplary method for extracting product review data from social media content according to an exemplary embodiment of the present disclosure; and

FIG. 4 depicts an exemplary computer-based system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for facilitating the exchange of information relating to product review data expressed by a reviewer in a social media platform or in other platforms such as email, blogs, documents, calendar data, and other data associated with the reviewer. The product review data can include a sentiment expression about a product or service shared by the reviewer with the social media platform. The reviewer can optionally make the product review data available to a third party entity that might be interested in the product review data, such as a business, advertiser, sponsor, or other entity associated with the product or service identified in the product review data. An interface can be provided between the reviewer and the entity that permits the entity to interact with the reviewer.

More particularly, a reviewer can optionally allow access to his or her social media content posted on a social media platform. With the reviewer's express informed consent, the reviewer's social media content can be analyzed to identify comments, statements, discussions, or other content related to products and services. For instance, a sentiment analysis technique can be used to identify a sentiment expression in the reviewer's social media content. The social media content surrounding the sentiment expression can be analyzed to identify a product or service. Product review data that includes the sentiment expression and the identity of the product or service can then be extracted. An entity associated with the product review data can be identified. An interface between the reviewers and the entity can be established.

The interface can be used to exchange communications between the reviewer and the entity regarding the extracted product review data. For instance, the entity can offer the reviewer an incentive to allow the entity to use the product review data or to make the product review data publicly accessible, for instance, by sharing the product review data with an online review platform. The entity can also use the interface to seek permission to allow the entity to address (e.g. post a reply to) the product review in the social media content shared by the reviewer with the social media platform. In this way, sentiment expressions provided as part of a reviewer's social media content can be identified and shared with the public or otherwise used to increase the visibility of the sentiment expression regarding a particular product and/or service. In addition, reviewers can be provided an opportunity to expose their social media content to determine if an entity would be willing to exchange an incentive or other benefit (e.g. money, coupon, discount, or other incentive) for use of the product review data.

The present disclosure will be discussed with reference to extracting product review data shared by the reviewer with a social media platform for purposes of illustration and discussion. However, those of ordinary skill in the art, using the disclosures provided herein, will understand that a reviewer can surface product review data extracted from other sources associated with the reviewer, such as email archives, calendar data, documents, blogs, and other sources associated with the reviewer. For instance, sentiment analysis techniques can be performed on other reviewer generated content expressed by the reviewer online. In particular, with reviewer's express informed consent, sentiment analysis techniques can be performed on the reviewer's email archives, chat archives, calendar data, documents, blogs, and other content generated by the reviewer to extract product review data. An entity associated with the product review data can be identified and an interface can be established between the entity and the reviewer to facilitate the exchange of information relevant to the product review data.

In situations in which the systems and methods discussed herein access and analyze personal information about users, or make use of personal information, such as social media content, email data, calendar data, documents, blogs, or other information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

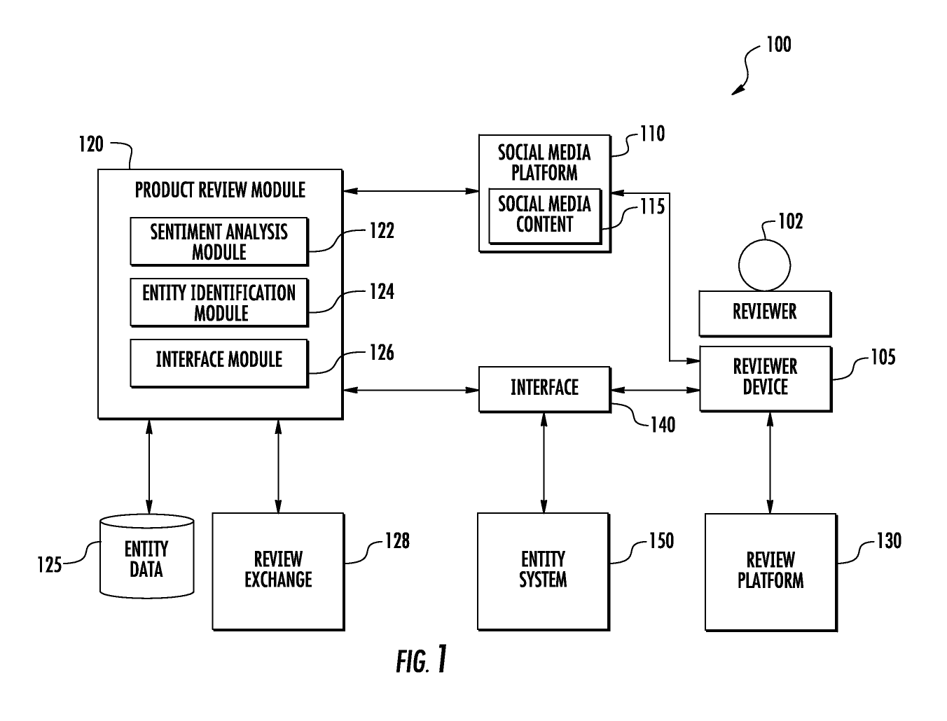

With reference now to the FIGS., exemplary embodiments of the present disclosure will now be set forth. FIG. 1 depicts an overview of an exemplary system 100 for facilitating the exchange of information relating to product reviews provided in social media content according to an exemplary embodiment of the present disclosure. The system 100 can include a social media platform 110. The social media platform 110 can be any platform, system, or service that allows a reviewer 102 to share information with members of the reviewer's social network. The social media platform can be implemented or hosted by any suitable computing device, such as a web server.

The reviewer 102 can interact with the social media platform 110 and other components of the system 100 using a reviewer device 105. The reviewer device 105 can be any suitable computing device, such as a laptop, desktop, smartphone, tablet, mobile device, wearable device, or other computing device. The reviewer device 105 can be in communication with the other components of the system 100 over a network (e.g. the Internet). The reviewer device 105 can present a suitable user interface (e.g. a browser) to the reviewer 102 that allows the reviewer 102 to interact with components of the system 100, including the social media platform 110. For instance, a reviewer may share social media content 115, such as photographs, stories, history, and/or comments, with members of the reviewer's social network using the social media platform 110.

The reviewer 102 may have submitted social media content 115 to the social media platform 110 that expresses sentiment about a particular product or service. For instance, the reviewer 102 may have submitted comments, statements, discussions or other content that expresses a sentiment regarding the particular productor service to the social media platform 120. For instance, the sentiment expression can pertain to restaurants, hotels, dining, software, sports venues, sporting events, movies, consumer goods, music, entertainment venues, or other products and/or services. Exemplary content that expresses sentiment can include: “Bought product X today and I love it,” “Restaurant A has the best food;” “I like store Y;” or other suitable expressions.

The social media content 115 shared by the reviewer 102 with the social media platform 110 may only be available to members of the reviewer's social network and may not be accessible by the general public. The reviewer 102 may want to determine whether there is an interest in the product review information provided in the social media content 115. For instance, the reviewer 102 may want to determine if an entity associated with a product or service discussed in the reviewer's social media content 115 would like to offer an incentive to the reviewer 102 to share the information outside of the reviewer's social media network. Accordingly, the reviewer 102 can decide to surface data in the reviewer's social media content 115 for access by one or more third parties. As used herein, surfacing data refers to making the data available for access.

More particularly, the reviewer 102 can give permission to access the social media content 115 to one or more third parties to allow them to determine their interest in the social media content 115 shared by the reviewer 102. According to aspects of the present disclosure, the system 100 can include a product review module 120 that can be implemented to identify product review data in the social media content 115. The product review module 120 can be implemented by any suitable computing device, such as a web server used to host the social media platform 110.

The product review module 120 can include a sentiment analysis module 122, an entity identification module 124, an interface module 126, and other suitable modules. It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

The sentiment analysis module 122 can be configured to access social media content 115 shared by the reviewer 102 with the social media platform 110. The sentiment analysis module 122 can be further configured to analyze the social media content 115 to extract product review data shared with the social media platform by the reviewer 102. The product review data can include a sentiment expression about a product or service. The sentiment analysis module 122 can extract the product review data by performing sentiment analysis techniques on the social media content 115 to identify sentiment expressions about a particular product or service. Exemplary sentiment analysis techniques will be discussed in more detail below.

The entity identification module 124 can be configured to match product review data extracted by the sentiment analysis module 122 with a particular entity associated with the product review data. The entity can be any suitable entity associated with the product review data, such as a business, manufacturer, supplier, distributor, retailer, advertiser, sponsor, or other entity that offers, sells, advertises, and/or promotes the product or service identified in the product review data. The entity can be identified by the entity identification module 124 using many suitable techniques. For instance, analysis can be performed on the product review data itself to determine if the entity is identified in the product review data. Alternatively, the product or service identified in the product review data, including contextual data surrounding the product or service in the product review data, can be associated with an entity by accessing information associated with a plurality of candidate entities stored in a database 125. In another implementation, the product review data can be provided to a review exchange 128 that provides a forum for interested entities to view and assess the product review data to determine whether the product review data is valuable to the entity.

The interface module 126 can be used to establish an interface 140 between the entity identified by the entity identification module 124 and the reviewer 102. The interface 140 can permit the exchange of information between the reviewer 102 and the entity. The interface 140 can provide a communication channel or medium between an entity system 150 associated with the identified entity and the reviewer device 105. The interface 140 can be implemented using any suitable communication medium, such as any suitable wireless or wired communication links or combinations thereof. In one particular implementation, the interface 140 provides for the exchange of communications between the entity and the reviewer over a network, such as the Internet.

A communication relating to the product review data can be exchanged between the entity system 150 and the reviewer 102 via the interface 140. The communication can take any suitable form, such as an email, text message, instant message, voice communication, video communication, text exchanged over a web interface, or other suitable form. For example, in one embodiment, the interface can include a web page that allows the reviewer and the entity to post and reply to messages submitted by the entity and the reviewer 102.

The communication can be related to the product review data extracted from the social media content 115 shared by the reviewer 102 with the social media platform. For example, the communication exchanged over the interface 140 can include an incentive offered by the entity to the reviewer 102 for a specified use of the product review data. In one implementation, the communication can offer an incentive for the reviewer 102 to make the product review data publicly accessible in the social media platform 110 or another platform or forum. In another implementation, the communication can offer an incentive for the reviewer 102 to allow the entity to use the product review data, for instance, for consumer research purposes. The incentive can be any suitable reward or other incentive such as a reward, money, discount, coupon, offer, or other suitable incentive.

In another particular implementation, the communication can offer the reviewer an incentive to post the product review data in a public review platform 130. The public review platform 130 can be a website, service, search engine, or other platform that provides the general public access to reviews of various products and services. The review platform 130 can be hosted by any suitable computing device, such as a web server. The review platform 130 can allow a reviewer 102 to submit reviews regarding various products or services. Other suitable communications can be provided between the reviewer 102 and the entity via the interface 140. For instance, the entity can seek reviewer consent to post a reply to a negative sentiment expression in the social media content 115.

The system 100 provides a tool that allows the reviewer 102 to surface product review data shared with a social media platform 110 to one or more entities to allow those entities to determine if there is any interest or value to the product review data. The product review data can be shared with interested entities that may want the product review data to become more publicly accessible. The interface 140 can facilitate the exchange of information between the reviewer 102 and interested entities relating to the product review data. As a result, reviewers can determine if there is value to the product review data shared with the social media platform 110 and entities can gain access to the product review data for beneficial purposes, such as making the product review data available to the general public.

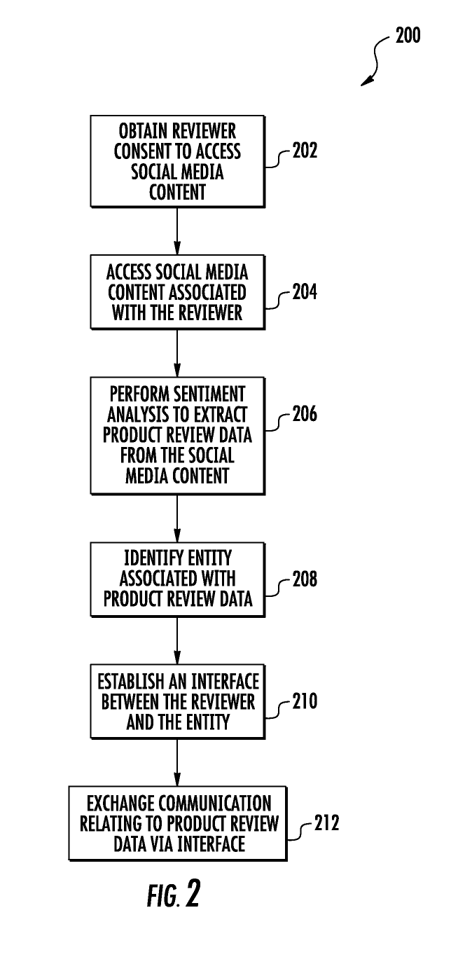

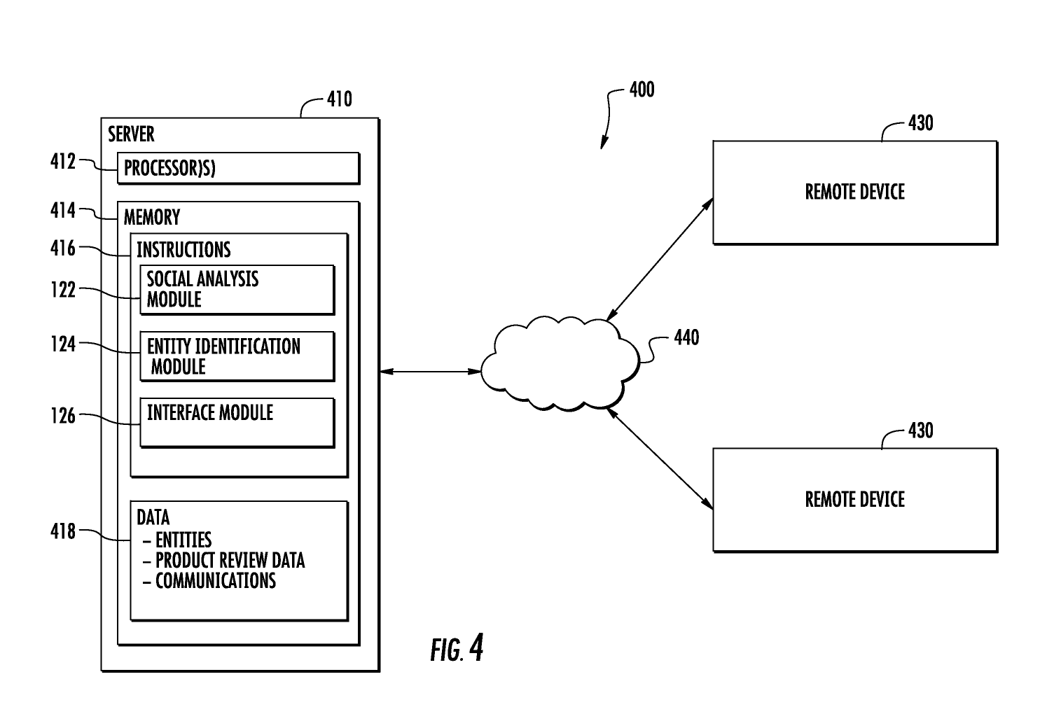

FIG. 2 depicts a flow diagram of an exemplary computer-implemented method (200) for facilitating the exchange of information relating to online product reviews according to an exemplary embodiment of the present disclosure. The method (200) of FIG. 2 can be implemented by any suitable computing device or system, such as the systems depicted in FIGS. 1 and 4. In addition, FIG. 2 depicts steps performed in a particular order for purposes of illustration and discussion. Those of ordinary skill in the art, using the disclosures provided herein, will understand that the various steps of any of the methods discussed herein can be omitted, rearranged, or adapted in various ways.

At (202), the method can include obtaining reviewer consent to access the social media content associated with the reviewer. For instance, the social media platform 110 of FIG. 1 or some other service can provide the reviewer 102 the option of surfacing social media content 115 to third parties to see if any entities are interested in the social media content 115. The option can be presented to the reviewer using a suitable user interface. For instance, a message can be presented to the reviewer asking whether the reviewer wants to surface social media content to the third parties when the content is first submitted. The message can inform the reviewer what data is going to be accessed and how the data is going to be used and/or maintained. The reviewer can provide consent by providing a suitable interaction indicative of consent. In one implementation, the reviewer can also adjust settings associated with the social media platform indicating whether and how social media content can be surfaced to third parties to determine whether any entities are interested in product review data found in the social media content. For example, the reviewer can choose to not surface the product review data, receive invitations to surface the data, or automatically surface the data. If the reviewer chooses to surface the product review data, the reviewer can specify which products and services or categories of products and services to surface, and the third parties to whom that information can be surfaced.

After receiving permission from the reviewer, social media content associated with the reviewer can be accessed as shown at (204) of FIG. 2. For instance, the product review module 140 can access social media content 115 shared by the reviewer with the social media platform 110. In one particular implementation, the product review module 140 can fetch social media content associated with the reviewer via a suitable application programming interface (API).

At (206), sentiment analysis techniques are performed on the social media content to extract product review data. The sentiment analysis techniques can be implemented, for instance, by the sentiment analysis module 122 of FIG. 1. The sentiment analysis techniques are used to identify sentiment expressions in the social media content. The sentiment expressions can be associated with products and/or services and extracted as product review data.

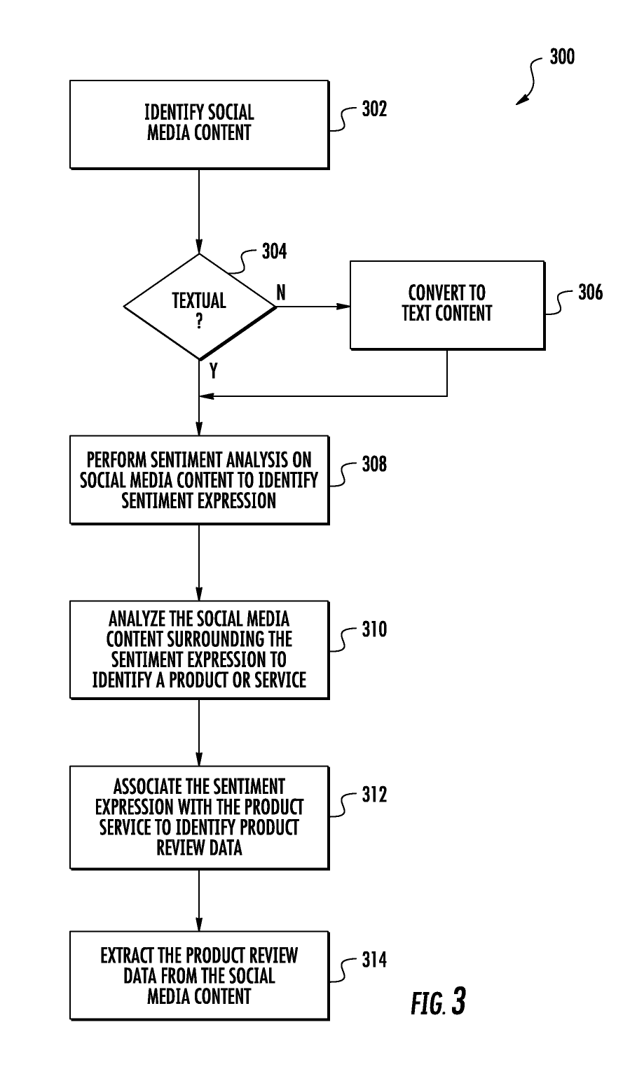

FIG. 3 depicts an exemplary method (300) for extracting product review data from social media content according to an exemplary embodiment of the present disclosure. At (302), social media content is identified. For instance, the social media content can be fetched from the social media platform via a suitable API. The identified social media content can be limited in time or based on other factors. For instance, to preserve computing resources, the identified social media content can be limited to content that has been submitted by the reviewer within a specified time frame. In addition, only certain types of social media content (e.g. comments, videos, etc.) can be identified. The reviewer can be provided the option to specify which types of social media content can be identified for sentiment analysis.

At (304), it is determined whether the social media content is textual content. The sentiment analysis techniques disclosed herein are typically suitable for textual data. When the social media content includes only textual data, the method can proceed to (308) where sentiment analysis is performed on the textual data. When the social media content includes non-textual content, the method can include performing sentiment analysis techniques on the audio or visual content itself. For instance, algorithms can be used to detect sentiment expressions such as laughter in audio content or laughter and/or smiles in video content. Sentiment expressions associated with products and/or services can be extracted as product review data. Various suitable algorithms for detecting laughter, smiles, frowns, and other sentiment expressions are known. Any of these suitable algorithms can be used without deviating from the scope of the present disclosure.

In addition and/or in the alternative, the method can include converting the content to textual content (306). For instance, if the social media content includes audio content or video content, the content can be converted to textual data using suitable audio to text conversion techniques. Those of ordinary skill in the art, using the disclosures provided herein, will understand that a variety of different techniques are available for converting audio or video content to textual data. Any of the techniques can be used without deviating from the scope of the present disclosure. Once the social media content has been converted to textual content, the method can proceed to (308) for sentiment analysis.

At (308), sentiment analysis is performed on the social media content to identify a sentiment expression. A variety of sentiment analysis techniques can be used to identify a sentiment expression. For instance, various algorithms can be used to identify positive or negative sentiment words (e.g. “good,” “bad,” “awful,” “great,” “excellent,” etc.) in the social media content. The sentiment expressions can be identified based on a database of predefined sentiment keywords. Searching techniques can be used to identify the keywords in the social media content. Grammatical rules and/or syntax rules can also be defined to identify when a sentiment associated with a word is being modified, such as determining when a positive sentiment word (e.g. “good”) is preceded by the word “not.”

In one particular implementation, the textual data of the social media content can be tokenized to produce a set of tokens. Each token can be subject to part-of-speech tagging to associate a part of speech with the token. The tokens can be subjected to natural language processing techniques such as stemming, word sense disambiguation and compound recognition. The set of tagged tokens can be analyzed to extract sentiment expressions. For instance, part of speech combinations (e.g. adjective, noun combinations; adverb, adjective, noun combinations; verb, adjective, noun combinations; pronoun, verb, adverb combinations; adjective, adverb, verb, noun combinations; or other combinations) can be extracted to identify a sentiment expression. Other methods of identifying sentiment expressions can be used, such as syntax trees or semantic grammars.

Once the sentiment expression has been identified, the textual content surrounding the sentiment expression can be analyzed to identify a product or service. For instance, textual data within a predefined number of characters can be identified and analyzed to identify the presence of keywords associated with product or services. The keywords can be a set of predefined keywords associated with various products or services specified in a database.

At (312), the sentiment expression is associated with the identified product or service to compose the product review data. The product review data can then be extracted for sharing with interested entities in accordance with aspects of the present disclosure (314).

Referring back to FIG. 2 at (208), an entity associated with the product review data is identified. For instance, the entity identification module 124 of FIG. 1 can be configured to match product review data with a particular entity associated with the product review data. The entity can be any suitable entity, such as a business, manufacturer, supplier, distributor, retailer, advertiser, sponsor, or other entity that offers, sells or promotes the product or service identified in the product review data.

In one particular implementation, the entity associated with the product review data can be identified by performing analysis on the product review data itself. For instance, the reviewer may have discussed or otherwise referred to the particular entity name (e.g. manufacturer name, business name, etc.) associated with the product or service in expressing sentiment about the product or service. In these cases, analysis techniques (e.g. textual analysis techniques) can be performed on the product review data to determine if the product review data identifies any particular entities. In one implementation, the product review data can be analyzed for the presence of keywords associated with particular entities that are stored, for instance, in a database of keywords identifying the particular entities.

In another particular implementation, the product review data can be associated with an entity based on a database of information containing candidate entities. The candidate entities can be a set of entities that are interested in obtaining product review data shared with a social media platform. For instance, the set of candidate entities can include entities that have subscribed to a service for receiving product review data. The candidate entities can provide information such as location, types of products and/or services offered by the entity, typical consumers of the products or services, and other information that can be helpful to identify a particular entity based on the product review data. The information can be stored in an entity database.

The product review data can be analyzed with respect to the information stored in the entity database to identify a particular entity associated with the product review data. For example, the product review data can identify a particular product by location (e.g. “the pizza restaurant at the corner of first and third is very good.”). The location identified in the product review data can be compared with the information associated with candidate entities stored in the entity database to determine if there is a match between a particular candidate entity and the specified location. If there is a match, the entity can be identified as being associated with the product review data.

According to yet another particular implementation, the product review data can be identified using a review exchange, such as the review exchange 128 of FIG. 1. The review exchange can provide a forum for interested entities to view product review data extracted from a social media platform according to aspects of the present disclosure. A reviewer can optionally surface product review data directly to the review exchange to determine if there is any interest in the product review data. An entity, such as an advertiser, manufacturer, sponsor, etc., subscribed to or with access to the review exchange can monitor the product review data surfaced to the review exchange to determine their level of interest in the product review data. If an entity expresses an interest in the product review data, an interface can be established between the entity and the reviewer. As will be discussed below, the entity can then offer various incentives to the reviewer for specified use of the product review data. In this way, the review exchange can provide a marketplace for product review data shared with reviewers in the social media platform.

Once an entity associated with the product review data has been identified, an interface is established between the entity and the reviewer (210). For instance, the interface 140 of FIG. 1 can be established between the entity and the reviewer. The interface permits the exchange of information related to the product review data between the reviewer and the entity. As discussed above, the interface can provide for the exchange of information using any suitable format over any suitable communication medium or combinations thereof.

At (212) of FIG. 2, the method includes exchanging a communication relating to the product review data via the interface. As used herein, exchanging a communication refers to providing at least one communication between the reviewer and the entity. The interface can facilitate the exchange of information between the reviewer and the entity as follows: The interface can receive a communication from the entity relating to the product review data, and can forward the communication to the reviewer. The reviewer can review the communication and provide a response to the entity through the interface.

The communication exchanged over the interface can include an incentive offered by the entity to the reviewer for a specified use of the product review data. The incentive can be any suitable reward or other incentive such as a reward, money, discount, coupon, offer, or other suitable incentive. The incentive can be offered for a variety of uses of the product review data. In one example, the communication can offer an incentive for the reviewer to make the product review data publicly accessible in the social media platform or other platform or forum. In another example, the communication can offer an incentive for the reviewer to allow the entity to use the product review data, for instance, for consumer research purposes. In yet another example, the communication can offer the reviewer an incentive to post the product review data in a public review platform. The entity can also use the communication to seek reviewer consent to post a reply to a negative or other sentiment expression in the social media content.

FIG. 4 depicts an exemplary computing system 400 that can be used to implement the methods and systems of facilitating the exchange of information related to online product reviews according to aspects of the present disclosure. The system 400 is a client-server architecture that includes a server 410 that communicates with one or more client devices 430 over a network 440. The system 400 can be implemented using other suitable architectures, such as a single computing device.

The system 400 includes a server 410, such as a web server. The server 410 can be used to host a social media platform. The server can be implemented using any suitable computing device(s). The server 410 can have a processor(s) 412 and a memory 414. The server 410 can also include a network interface used to communicate with one or more remote computing devices (i.e. client devices) 430 over a network 440.

The processor(s) 412 can be any suitable processing device, such as a microprocessor, microcontroller, integrated circuit, or other suitable processing device. The memory 414 can include any suitable computer-readable medium or media, including, but not limited to, non-transitory computer-readable media, RAM, ROM, hard drives, flash drives, or other memory devices. The memory 414 can store information accessible by processor(s) 412, including instructions 416 that can be executed by processor(s) 412. The instructions 416 can be any set of instructions that when executed by the processor(s) 412, cause the processor(s) 612 to provide desired functionality. For instance, the instructions 416 can be executed by the processor(s) 412 to implement the sentiment analysis module 122, the entity identification module 124, and the interface module 126 discussed with reference to FIG. 1.

Referring to FIG. 4, memory 414 can also include data 418, such as entity data, product review data, and/or communications exchanged between a reviewer and an entity, etc., that can be retrieved, manipulated, created, or stored by processor(s) 412. The data 418 can be stored in one or more databases. The one or more databases can be connected to the server 410 by a high bandwidth LAN or WAN, or can also be connected to server 410 through network 440. The one or more databases can be split up so that they are located in multiple locales.

The server 410 can exchange data with one or more client devices 430 over the network 440. Although two clients 430 are illustrated in FIG. 4, any number of client devices 430 can be connected to the server 410 over the network 440. The client devices 430 can be any suitable type of computing device, such as a general purpose computer, special purpose computer, laptop, desktop, integrated circuit, mobile device, smartphone, tablet, or other suitable computing device.

Similar the computing device 410, a client device 430 can include a processor(s) and a memory. The memory can store information accessible by processor(s), including instructions that can be executed by processor(s) and data. The client device 430 can include various input/output devices for providing and receiving information from a user, such as a touch screen, touch pad, data entry keys, speakers, and/or a microphone suitable for voice recognition. For instance, the computing device 430 can have a display for presenting information, such as reviews and communications from entities associated with product review data, to a user.

The network 440 can be any type of communications network, such as a local area network (e.g. intranet), wide area network (e.g. Internet), or some combination thereof. The network 440 can also include a direct connection between a client device 430 and the server 410. In general, communication between the server 410 and a client device 430 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of facilitating the exchange of information related to online product reviews, the method comprising:
accessing, with a computing device, reviewer generated content associated with a reviewer, the reviewer generated content comprising information about a product or service;
analyzing, with the computing device, the reviewer generated content to extract product review data, the product review data comprising a sentiment expression and an identity of the product or service;
identifying an entity associated with the product or service identified in the product review data; and
establishing an interface between the reviewer and the entity, the interface permitting the exchange of information between the reviewer and the entity.

2. The method of claim 1, further comprising exchanging a communication between the reviewer and the entity via the interface.

3. The computer-implemented method of claim 1, wherein the reviewer generated content comprises social media content shared by the reviewer with a social media platform.

4. The computer-implemented method of claim 1, wherein the reviewer generated content comprises one or more of emails, documents, calendars, or blogs generated by the reviewer.

5. The computer-implemented method of claim 2, wherein the communication offers the reviewer an incentive to allow the entity to use the product review data.

6. The computer-implemented method of claim 2, wherein the communication offers the reviewer an incentive to make the product review data publicly accessible.

7. The computer-implemented method of claim 2, wherein the communication offers the reviewer an incentive to post the product review data in an online public review platform.

8. The computer-implemented method of claim 2, wherein the communication requests the reviewer's consent to permit the entity to post a reply to the product review data in the social media content.

9. The computer-implemented method of claim 1, wherein analyzing the social media content to extract product review data comprises:
performing a sentiment analysis on the social media content to identify the sentiment expression;
analyzing the social media content surrounding the sentiment expression to identify the product or service; and
extracting the product review data from the social media content, the product review data comprising the sentiment expression and the identity of the product or service.

10. The computer-implemented method of claim 1, wherein the social media content comprises textual content, audio content, or video content.

11. The computer-implemented method of claim 1, further comprising providing a notification to the entity of the product review data.

12. The computer-implemented method of claim 1, wherein the entity is a business, advertiser, or sponsor associated with the product or service.

13. The computer-implemented method of claim 1, wherein the method comprises receiving a request from the reviewer to surface social media content prior to accessing the social media content associated with the reviewer.

14. The computer-implemented method of claim 1, wherein identifying the entity associated with the product or service identified in the product review data comprises:
accessing a database storing information associated with a plurality of candidate entities;
identifying the entity from among the plurality of candidate entities based at least in part on the product review data.

15. The computer-implemented method of claim 14, wherein the entity is identified based at least in part on the product or service identified in the product review data.

16. The computer-implemented method of claim 1, wherein identifying the entity associated with the product or service identified in the product review data comprises:
providing a forum for interested entities to assess the product review data;
receiving a request from an interested entity to communicate with the reviewer;
identifying the entity from the request.

17. A computing system comprising:
one or more memory devices storing instructions; and
one or more processors, configured to execute the instructions stored in the one or more memory devices in order to perform operations, the operations comprising:
accessing reviewer generated content associated with a reviewer, the reviewer generated content comprising information about a product or service;
analyzing the reviewer generated content to extract product review data, the product review data comprising a sentiment expression and an identity of the product or service;
identifying an entity associated with the product or service identified in the product review data; and
establishing an interface between the reviewer and the entity, the interface permitting the exchange of information between the reviewer and the entity.

18. The computing system of claim 17, wherein analyzing the social media content to extract product review data comprises:
performing a sentiment analysis on the social media content to identify a sentiment expression;
analyzing the social media content surrounding the sentiment expression to identify a product or service; and
extracting the product review data from the social media content, the product review data comprising the sentiment expression and an identity of the product or service.

19. A computer program product comprising a tangible non-transitory computer readable medium storing computer readable instructions that when executed by a processing device cause the processing device to perform operations, the operations comprising:
accessing reviewer generated content associated with a reviewer, the reviewer generated content comprising information about a product or service;
analyzing the reviewer generated content to extract product review data, the product review data comprising a sentiment expression and an identity of the product or service;
identifying an entity associated with the product or service identified in the product review data; and
establishing an interface between the reviewer and the entity, the interface permitting the exchange of information between the reviewer and the entity.

20. The computer program product of claim 19, wherein the operation of analyzing the social media content to extract product review data comprises:
performing a sentiment analysis on the social media content to identify a sentiment expression;
analyzing the social media content surrounding the sentiment expression to identify a product or service; and
extracting the product review data from the social media content, the product review data comprising the sentiment expression and an identity of the product or service.
